(19) United States
(12) Patent Application Publication
(10) Pub. No.: US 2026/0163718 A1
(43) Pub. Date: Jun. 11, 2026

(54) PACKING VARIABLE LENGTH CIPHERTEXT INSTANCES IN A DATA STREAM

(71) Applicant: INTERNATIONAL BUSINESS MACHINES CORPORATION, ARMONK, NY (US)

(72) Inventor: Glen Alan Jaquette, Tucson, AZ (US)

(21) Appl. No.: 18/975,952

(22) Filed: Dec. 10, 2024

(51) Int. Cl. H04L 9/06; H04L 9/32

(52) U.S. Cl. CPC H04L 9/0618; H04L 9/3242

(57) ABSTRACT

Provided are a computer implemented method, system, and computer program product for packing variable length ciphertext instances into a self-describing data stream. A determination is made whether a compressibility of a block of data exceeds a compression threshold. The block of data is compressed to form compressed data. In response to determining that the compressibility exceeds the compression threshold, the compressed data is encrypted to generate ciphertext. A scheme field is generated in a packed stream indicating the ciphertext includes compressed data. The storage system processes the scheme field to access the ciphertext following the scheme field. The packed stream is transmitted to the storage system which can store the packed stream untouched, parse the packed stream to create or verify associated metadata, or extract the ciphertext from the packed stream and only store that.

### BACKGROUND OF THE INVENTION

### 1. Field of the Invention

The present invention relates to a computer implemented method, system, and computer program product for packing variable length ciphertext instances in a data stream.

### 2. Description of the Related Art

Streaming compressed data across some data interconnects requires that each data block or sector added to the stream has a fixed length. However, compressing a sector of fixed length data results in variable length data. The encoded data stream includes a fixed length header and other fixed length fields, and the encrypted sector, which may be compressed. If the encrypted sector is compressed, then a zero pad of zeroes is added to the end of the encrypted data to ensure the encoded data block has the same length of the input sector. If the sector data is not sufficiently compressible, or is effectively incompressible, then the full sector is encrypted with a non-expanding encryption mode and added to the data stream without padding because the length of the encrypted sector is the length of the input sector.

### SUMMARY

Provided are a computer implemented method, system, and computer program product for packing variable length ciphertext instances in a data stream. A determination is made whether a compressibility of a block of data exceeds a compression threshold. The block of data is compressed to form compressed data. In response to determining that the compressibility exceeds the compression threshold, the compressed data is encrypted to generate ciphertext. A scheme field is generated in a packed stream indicating the ciphertext includes compressed data. The storage system processes the scheme field to access the ciphertext following the scheme field. The packed stream is transmitted to the storage system to extract the ciphertext from the packed stream to store in the storage system.

### BRIEF DESCRIPTION OF THE DRAWINGS

FIG. 1 illustrates an embodiment of a computing environment including an object manager to encode data to stream to a storage system.

FIGS. 2 and 4 illustrate embodiments of encoded data blocks.

FIG. 3 illustrates an alternative embodiment of the object manager to encode data.

FIG. 5 illustrates an embodiment of operations to encode and stream a data block with the object manager of FIG. 1.

FIG. 6 illustrates an embodiment of operations to encode and stream a data block with the object manager of FIG. 3.

FIG. 7 illustrates a computing environment in which the components of FIGS. 1 and 3 may be implemented.

### DETAILED DESCRIPTION

To allow compression and encryption of fixed length blocks, such as sectors at logical block addresses (LBAs), an encoder may pad the end of the compressed blocks so that the entire encoded data block has the same length as the input sector being compressed and encrypted. When streaming data to cloud storage or for cloud processing, the cumulative amount of padding between the sectors can consume a significant amount of empty space in the stream between instances of the sectors.

Described embodiments provide improvements to computer technology for encoding compressed and encrypted data that avoids the need to pad the end of the encrypted and compressed data, the ciphertext, with zeroes. Described embodiments add a field having a unique identifier, such as a repeated pattern of data, e.g. all zeroes, all ones, etc., to a field in the encoded data block indicating whether the data block is encoded or unencoded. The encoder may further add a compressed data length of the ciphertext, which may be a variable length due to compression. The decoder upon detecting the expected repeated pattern would know to process the data block as encoded, to access the ciphertext following the fixed fields in the encoded data block. The compressed data length is included in the encoded data block to allow the decoder to efficiently parse the end of the ciphertext in the encoded data block, which may have variable length. If the decoder does not detect the repeated pattern, then the decoder would recognize the entire data block as ciphertext as there was no compression and the length of the ciphertext is the full length of the data block.

In further embodiments, the encoder may include a keyed hash of the compressed data in the data block. The decoder may use this keyed hash to determine which ciphertext instances in the stream are identical. The decoder may then perform data deduplication to allow transmission or storage of only one instance of a repeated ciphertext in the stream. Providing the keyed hash calculated from the compressed data before encryption allows the decoder to perform deduplication on encrypted and compressed data.

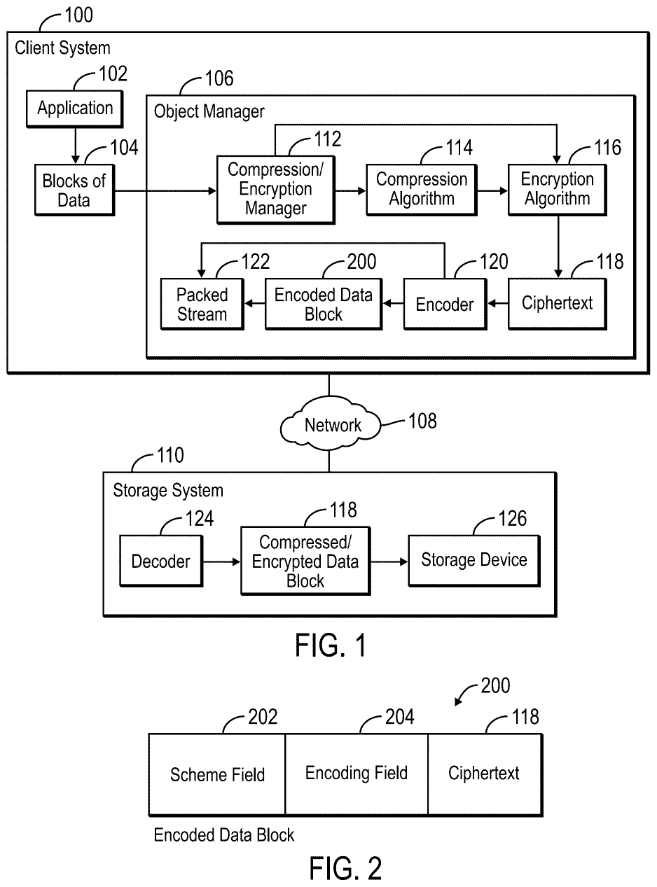

FIG. 1 illustrates an embodiment of a client system 100 including an application 102, such as a backup program or file system, that outputs blocks of data 104 to an object manager 106. The object manager 106 performs compression, encryption and encodes the blocks of data 104 to stream over a network 108 to a storage system 110. The object manager 106 includes a compression/encryption manager 112 to utilize a compression algorithm 114 and encryption algorithm 116 to compress and encrypt the blocks of data 104 producing a compressed/encrypted data block 118. The mode of the encryption algorithm 116 may include ciphertext stealing (as XTS mode of encryption does) or some other suitable non-expanding encryption algorithm (e.g. IEEE 1619.2's EME2 ). The compression/encryption manager 112 may determine whether to invoke the compression algorithm 114 to compress the data block 104 if the data block 104 has a suitable compressibility. After compressing the data block, the compressed data block is input to the encryption algorithm 116 to encrypt. Alternatively, if compressibility is insufficient, the compression/encryption manager 112 may bypass the compression algorithm 114 and invoke the encryption algorithm 116 to encrypt the cleartext block of data 104. The output of the encryption algorithm 116 comprises the ciphertext 118 which may be smaller due to compression or may be the original uncompressed size.

If the ciphertext is smaller due to compression, then the encoder 120 may encode fields into an encoded data block 200 which is then appended to the packed stream 122. If the ciphertext 118 is of uncompressed data, then the encoder 120 may append the ciphertext 118 to the packed stream 122 according to an encoding scheme without any additional metadata describing the ciphertext 118.

The encoded data block 200, as shown in FIG. 2, may include a scheme field 202 indicating that the data comprises an encoded data block 200 with encrypted variable length compressed data. The scheme field 202 may comprise a repeated byte pattern, such as all zeroes, all ones or some other pattern, to indicate the current data block has encoding related fields for compressed data. The encoded data block 200 further includes an encoding field 204 which may indicate a compressed data length of the compressed data, which is also the length of the ciphertext 118, to allow fast processing of the packed stream 122. The ciphertext 118 may follow the encoding field. In an alternative embodiment, the first field for a data block in the stream may comprise the encoding field followed either immediately by (or at some fixed distance beyond some amount of ciphertext) the scheme field, further followed by the rest of the compressed ciphertext 118.

FIG. 2 shows one embodiment for the arrangement of the fields 202, 204, and 118 in an encoded data block 200. In alternative embodiments, the fields may be in different locations and offsets than shown.

The encoded data block 200 may not include padding following the ciphertext 118 to allow for variable length encoded data blocks that do not waste space with zero padding in the packed stream.

The storage system 110 may or may not include a decoder 124 to recognize the blocks of data in the packed stream 122 as an encoded data block 200 or ciphertext 118. The decoder 124 will output the ciphertext 118, which may or may not be compressed, and store in the storage device 126. In an alternative embodiment, the packed data stream is stored (e.g. to an object store which may be local or in a cloud), in which case the only parsing which might be needed is to quickly find and count sector boundaries so that the sector span stored in that object can be known and possibly recorded as additional metadata associated with that object.

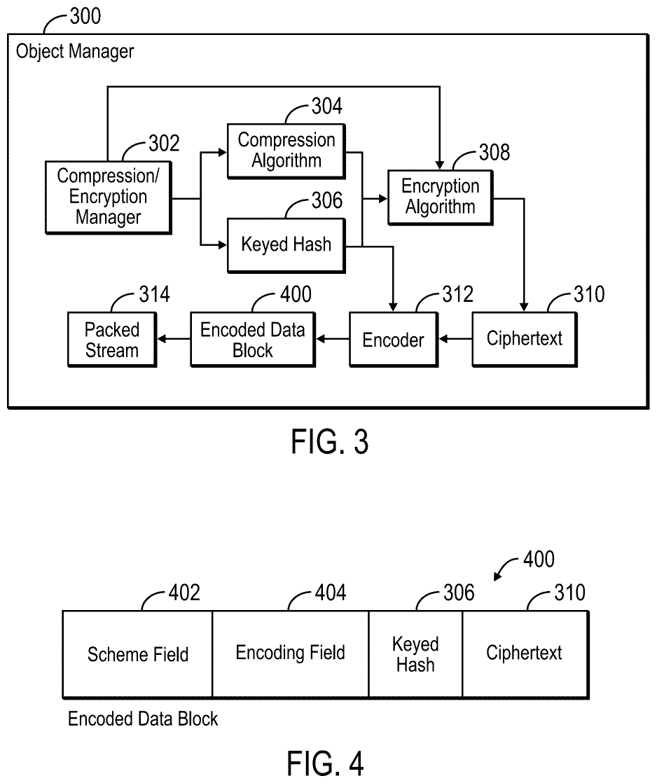

FIG. 3 illustrates an alternative embodiment of the object manager 300 including a compression/encryption manager 302 to determine whether to invoke the compression algorithm 304 if the compressibility of the block of data satisfies a compression threshold. The compression/encryption manager 302 generates a keyed hash 306 from the data using some number of bytes output from a hash algorithm, such as a cryptographic hash function, such as a secure hash algorithm, e.g. SHA-1, SHA-2, SHA-3, etc. The keyed hash may be calculated across the fixed length data received to be written, or “before compression”. In an alternative embodiment, the keyed hash may be calculated across the compressed data. The encryption algorithm 308 may then encrypt the compressed data using the keyed hash 306 as the XTS tweak, directly permuting the encryption of the compressed data. If the data block is not sufficiently compressible, then the compression/encryption manager may skip compression and call the encryption algorithm 308 to encrypt the cleartext data. The output of the encryption algorithm comprises the ciphertext 310, which may be smaller due to compression or may be same size as the original data. An encoder 312 receives the ciphertext 310 and the keyed hash 306 and generates an encoded data block 400 to add to the packed stream 314.

The encoded data block 400 includes a scheme field 402, such as scheme field 202, that has a repeated pattern to indicate the data block has encrypted variable length compressed data. The encoded data block 400 further includes an encoding field 404 indicating a compressed data length of the ciphertext 118 and the key hashed 306, followed by the ciphertext 310. In an alternative embodiment, the first field may comprise the encoding field followed either immediately or at some fixed offset after the scheme field, followed by the keyed hash and then the compressed ciphertext.

FIG. 4 shows one embodiment for the arrangement of the fields 402, 404, 306, and 310 in an encoded data block 400. In alternative embodiments, the fields may be in different locations and offsets than shown.

With the embodiment of FIG. 3, the storage system may use the keyed hash 306 to perform deduplication of the compressed and encrypted ciphertext. This allows the data to remain encrypted at all times in the storage system and still allow the storage system to perform deduplication of compressed and encrypted data. If two ciphertext instances have a same keyed hash, then they comprise identical data. In other words, identical compressible blocks produce identical ciphertext blocks. The storage system may subject ciphertext having the same keyed hash to deduplication so that only one copy of the repeated ciphertext is stored. If the ciphertext is stored unencoded, then the storage system may subject duplicate unencoded ciphertext instances in the packed stream 314 to deduplication to store only one copy of the unencoded ciphertext.

The block of data may comprise a sector, data for a logical block address (LBA), having a fixed length or other types of groupings of data.

The network 108 may comprise a network such as a Storage Area Network (SAN), Local Area Network (LAN), Intranet, the Internet, Wide Area Network (WAN), peer-to-peer network, wireless network, arbitrated loop network, etc.

The arrows shown in FIGS. 1 and 3 between the components and objects represent a data flow between the components.

Generally, program modules, such as the program components 100, 102, 112, 114, 116, 120, 124, 300, 302, 304, 308, 312 may comprise routines, programs, objects, components, logic, data structures, and so on that perform particular tasks or implement particular abstract data types. The program components and hardware devices of the computing devices 100, 110 (FIG. 1) may be implemented in one or more computer systems, where if they are implemented in multiple computer systems, then the computer systems may communicate over a network.

The program components 100, 102, 112, 114, 116, 120, 124, 300, 302, 304, 308, 312 may be accessed by a processor from memory to execute. Alternatively, some or all of the program components 100, 102, 112, 114, 116, 120, 124, 300, 302, 304, 308, 312 may be implemented in separate hardware devices, such as Application Specific Integrated Circuit (ASIC) hardware devices, Field Programmable Gate Arrays (FPGAs), etc. Still further, the object managers 106, 300 and all their components may be implemented in a hardware accelerator or a network adaptor.

The functions described as performed by the program 100, 102, 112, 114, 116, 120, 124, 300, 302, 304, 308, 312 may be implemented as program code in fewer program modules than shown or implemented as program code throughout a greater number of program modules than shown.

The storage system 110 may comprise a cloud storage. In such case, the object manager may implement an object streaming protocol, such as Ceph®, to distribute the packed streams across multiple storage devices in an object storage format. The Ceph allows for variable length ciphertext due to compression of the fixed length blocks of data. In such case, the Ceph protocol may perform the encoder operations 312 to encode data in a packed stream. Further, at the storage system side the Ceph protocol may implement the decoder to access the ciphertext from the received stream of objects to store in storage. (CEPH is a trademark of Red Hat, Inc. throughout the world.) In this way, the object manager may implement distributed object storage to store the ciphertext in the packed stream across storage devices.

Currently, Ceph utilizes metadata being passed in parallel with the data stream indicating the exact byte location of the start of each sector. This is potentially a significant amount of metadata. With the described embodiments, by having self-describing data within the packet allows Ceph data in a RADOS (Reliable Autonomic Distributed Object Store) object to be efficiently unpacked without relying on that metadata. On a host write to Ceph's fixed block capability (i.e., to Ceph's RBD (RADOS Block Device), if it were extended to support the embodiment of FIG. 1, the RBD encodes to an encoded data block 200 and data from the RBD is packed before transmission to RADOS, reducing the amount of data to be sent by the compression ratio. RADOS can stream the data into the objects it stores because it no longer has to do the packing. On a host read from an RBD, RADOS can stream the packed data in an encoded data block 200 it reads from the objects and transmit that packed data to RBD. In this way, data sent from RADOS to RBD is already packed, reducing the amount of data to be communicated between the two by the compression ratio achieved when RBD processed the host write. The RBD decodes the packed encoded data block 200 stream to produce the fixed block data the host expects

The storage devices 126 may comprise non-volatile storage devices, including, but not limited to, hard disk drives, solid state drives, and other types of storage devices. The storage devices 126 may further be configured into an array of devices, such as Just a Bunch of Disks (JBOD), Direct Access Storage Device (DASD), Redundant Array of Independent Disks (RAID) array, virtualization device, etc.

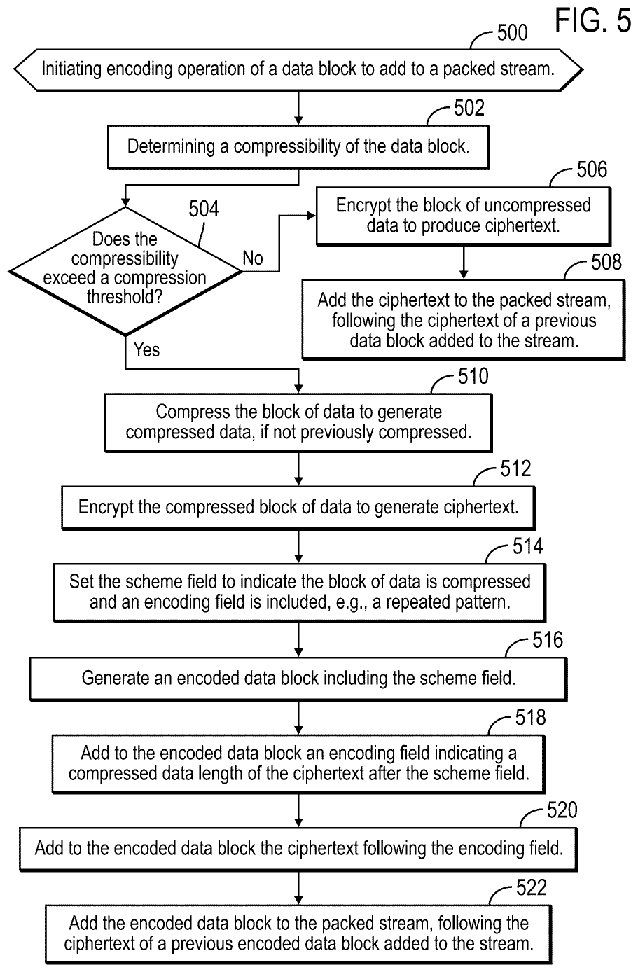

FIG. 5 illustrates an embodiment of operations performed by the object manager 106 and components therein to encode a fixed length data block in a packed stream. Upon initiating (at block 500) encoding operations, the object manager determines (at block 502) compressibility of the data block. In one embodiment, the compression/encryption manager 112 may determine compressibility by compressing the block of data and comparing to a compression ratio to determine if the amount of compression is sufficient. In an alternative embodiment, compressibility may be determined without having to compress the data. For instance, the compression/encryption manager 112 may calculate a Shannon entropy from the block of data to measure the randomness of the data. The entropy may be compared to a compression threshold comprising an entropy threshold. Lower entropy or randomness indicates higher compressibility and higher entropy indicates lower compressibility. Compressibility may also be determined by the type of data or other methods of determining compressibility.

If (at block 504) the compressibility does not exceed a compression threshold, indicating the data is not sufficiently compressible, then the block of uncompressed data is encrypted (at 506) using an encryption algorithm, such as encryption algorithm 116, to produce unencoded and uncompressed ciphertext, such as ciphertext 118. The ciphertext is added (at block 508) to the packed stream 122 following the last added ciphertext block. If (at block 504) the compressibility exceeds the compression threshold, i.e., sufficiently compressible, then, if it has not already been compressed in step 502, the block of data is compressed using a compression algorithm, such as compression algorithm 114, (at block 510) to generate compressed data. The compressed data is encrypted (at block 512) to generate the ciphertext. The encoder, such as encoder 120, may set (at block 514) the scheme field 202 to indicate an encoded data block with encrypted variable length compressed data. The scheme field may be set to a repeated pattern, e.g., all zeroes, all ones, etc., to indicate the data comprises compressed data of a variable length. The decoder 124 upon detecting the scheme field 202 would then know that the ciphertext is encoded with encoding fields indicating encrypted variable length compressed data as opposed to an unencoded data block with ciphertext comprising encrypted uncompressed fixed length data.

The encoder generates (at block 516) an encoded data block including the scheme field. An encoding field indicating a compressed data length of the ciphertext is added (at block 518) to the encoded data block after the scheme field. Alternatively, the scheme field may immediately, or at some fixed offset, follow the encoding field. The ciphertext is added (at block 520) to the encoded data block following the encoding field. The encoded data block is added (at block 522) to the packed stream, following the ciphertext of a previous encoded data block added to the stream. The packed stream may be transmitted to the storage system which can store the packed stream untouched, parse the packed stream to create or verify associated metadata, or extract the ciphertext from the packed stream and only store that.

With the described embodiments of FIG. 5, the ciphertext is not padded at the end even though the ciphertext may comprise variable length data due to compression. If compression is involved in producing the ciphertext, then the ciphertext is encoded with a scheme field to indicate the data is encoded with compressed data and the encoding field indicating the compressed data length of the variable length compressed ciphertext. However, if the ciphertext is not compressed, then there is no encoding field, just the start of the ciphertext. In such case, the decoder in the storage system will determine the ciphertext is unencoded and start at the beginning of the location in the stream for the data block. With the embodiment of FIG. 5, there is no padding following the variable length ciphertext to maximize the number of ciphertext instances that are included in the packed stream and reduce data transmission to conserve network bandwidth.

With the encoding scheme, the decoder in the storage system can efficiently parse the stream. If the bytes at the location of the scheme field do not have the expected repeated pattern indicating the ciphertext was encoded, then the decoder processes the fixed length of the block because there was no compression. If the bytes at the location of the scheme field have the expected repeated pattern indicating an encoding, then the decoder accesses the ciphertext at the expected location of the encoded data block and access the number of bytes indicated in the length of the ciphertext indicated in an encoding field. Also, the decoder knows the next data block, encoded or unencoded, immediately follows the last accessed ciphertext because there is no padding. Further, with this scheme, there is no padding even though there are variable length ciphertexts in the stream.

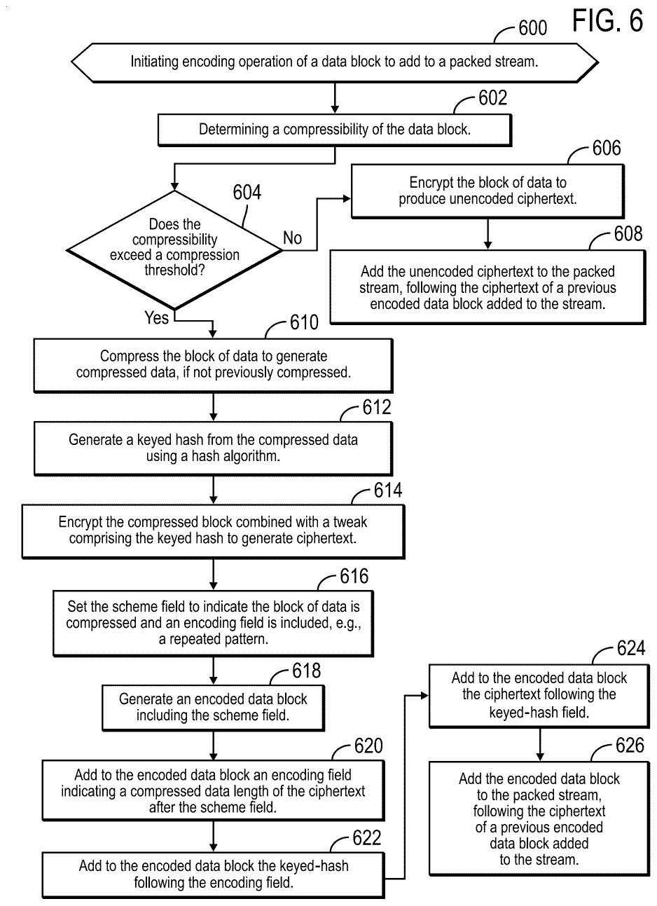

FIG. 6 illustrates an embodiment of operations performed by the object manager 300 of FIG. 3 and components therein to encode a data block in a packed stream. Upon initiating (at block 600) encoding operations, the object manager determines (at block 602) compressibility of the data block, as described above. If (at block 604) the compressibility does not exceed a compression threshold, indicating the data is not sufficiently compressible, then the block of data is encrypted (at 606) using an encryption algorithm, such as encryption algorithm 116, to produce unencoded and uncompressed ciphertext, such as ciphertext 310. The ciphertext is added (at block 608) to the packed stream 122 following the last added ciphertext. If (at block 604) the compressibility exceeds the compression threshold, then, if the data was not already compressed as part of block 602, the block of data is compressed using a compression algorithm, such as compression algorithm 304, (at block 610) to generate compressed data. The compression/encryption manager 302 may then generate (at block 612) a keyed hash from the compressed data using a hash algorithm, such as a cryptographic hash algorithm.

The compressed data is combined (at block 614) with a tweak, comprising the keyed hash, to generate the encrypted ciphertext. Non-compressible blocks require the tweak for security so all are unique and not deduplicateable. The encoder, such as encoder 312, may set (at block 616) the scheme field 402 to indicate an encoded data block with encrypted variable length compressed data, which may comprise a repeated pattern. The decoder 124 upon detecting the repeated pattern in the scheme field 402 would then know that the ciphertext is encoded with fields and includes variable length compressed data as opposed to unencoded fixed length ciphertext.

The encoder then generates (at block 618) an encoded data block including the scheme field. An encoding field indicating a length of the ciphertext is added (at block 620) to the encoded data block after the scheme field. Alternatively, the scheme field may follow the encoding field. The keyed hash is added (at block 622) to the encoded data block following the encoding field, or at some other location. The ciphertext is added (at block 624) to the encoded data block following the keyed hash. The encoded data block is added (at block 626) to the packed stream, following the previous ciphertext added to the stream. The packed stream may be transmitted to the storage system which can store the packed stream untouched, parse the packed stream to create or verify associated metadata, or extract the ciphertext from the packed stream and only store that.

With the described embodiments of FIG. 6, the ciphertext is not padded at the end even though the ciphertext may comprise variable length data due to compression. If compression is involved in producing the ciphertext, then the ciphertext is encoded with a scheme field to indicate the data is encoded and the encoding field indicating the compressed data length of the variable length ciphertext and a keyed hash. However, if the ciphertext is not compressed, then there are no encoding fields, just the start of the unencoded and encrypted uncompressed ciphertext. In such case, the decoder in the storage system will determine the ciphertext is unencoded and starts at the beginning of the location in the stream for the data block to read the fixed length of the data block. With the embodiment of FIG. 6, there is no padding following compressed variable length ciphertext. Avoiding padding maximizes the number of ciphertext instances that are included in the packed stream and reduce data transmission to conserve network bandwidth.

With the encoding scheme, the decoder in the storage system can efficiently parse the stream. If the bytes at the location of the scheme field do not have the expected repeated pattern indicating the ciphertext was encoded, then the decoder processes the next expected bytes of the stream as the ciphertext because there was no compression. If the bytes at the location of the scheme field have the expected repeated pattern indicating an encoding, then the decoder accesses the ciphertext at the expected location of the encoded data block and access the number of bytes indicated in the length of the ciphertext indicated in an encoding field. Also, the decoder recognizes the next data block, encoded or unencoded, immediately follows the last accessed ciphertext because there is no padding. Further, with this scheme, there is no padding even though there are variable length ciphertexts in the stream.

Further, the decoder may also use the keyed hash of a ciphertext block to determine if multiple different ciphertext blocks in the packed stream have the same keyed hash, which indicate they are the same compressed and encrypted. In such case, the decoder may use deduplication to only store one instance of the repeated ciphertext in storage to further compress the stored ciphertext instances and conserve storage space. The decoder may calculate keyed hashes to perform deduplication with respect to uncompressed and unencoded ciphertext to store only instance of such ciphertext even though the ciphertext is repeated in the stream.

With the described embodiments, encoded data at the host side still allows the storage system to compress and deduplicate data. However, with described embodiments, blocks that will not compress are encrypted and sent to storage without prepended metadata and which may (e.g., when EME2 mode encryption is used) or may not (e.g., when XTS mode encryption is used) permit deduplication. Encryption modes other than EME2 and XTS may be used.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

In the flowcharts and description, when there is a condition with different operations described as performed depending on the result of the condition, all results of the condition may occur at different times resulting in the different operations performed for the different results of the condition at different times.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

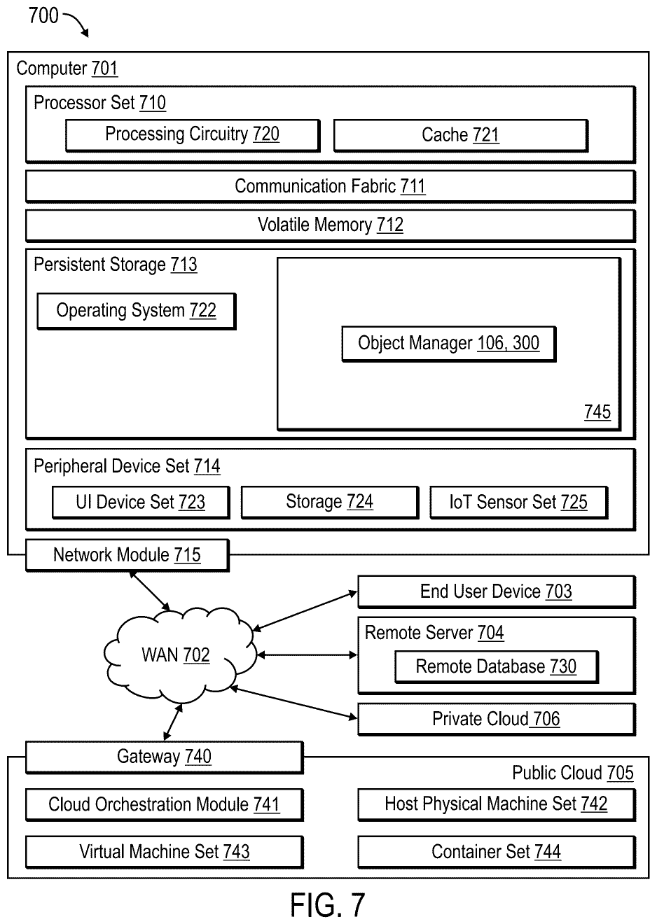

With respect to FIG. 7, computing environment 700 contains an example of an environment for the execution of at least some of the computer code involved in performing the inventive methods, such as block 745 including the object manager 106, 300 to encode variable length ciphertext in a data stream without having to add padding at the end of the variable length ciphertext instances. In addition to block 745, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 745, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer-readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 745 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN), the control functions and the forwarding functions of network module 715 are performed on physically separate devices, such that the control functions manage several different network hardware devices. Computer-readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704. The remote server 704 may comprise the storage system 110 of FIG. 1 to which the packed stream is streamed.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

CLOUD COMPUTING SERVICES AND/OR MICROSERVICES (not separately shown in FIG. 7): private and public clouds 706 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method for packaging data to transfer to a storage system to store, comprising:
determining whether a compressibility of a block of data exceeds a compression threshold;
compressing the block of data to form compressed data;
in response to determining that the compressibility exceeds the compression threshold, performing:
encrypting the compressed data to generate ciphertext; and
generating in a packed stream a scheme field indicating the ciphertext includes compressed data, wherein the storage system processes the scheme field to access the ciphertext following the scheme field; and
transmitting the packed stream to the storage system to extract the ciphertext from the packed stream to store in the storage system.

2. The computer implemented method of claim 1, wherein the generating the packed stream includes an encoding field indicating a compressed data length, wherein the storage system processes the encoding field to determine a start of a next block of data in the packed stream following the compressed data length from a start of the ciphertext, wherein ciphertext instances in the packed stream are of variable length due to compression.

3. The computer implemented method of claim 2, wherein the scheme field comprises a first field in the packed stream for the data block and the encoding field follows the scheme field, and wherein the ciphertext follows the encoding field.

4. The computer implemented method of claim 2, wherein the encoding field comprises a first field in the packed stream for the data block and the scheme field follows the encoding field, and wherein the ciphertext follows the scheme field.

5. The computer implemented method of claim 2, wherein the determining whether the compressibility of the block of data exceeds the compression threshold comprises determining whether a number of bytes of the block of data less a number of bytes blocks of the compressed data is at least a number of bytes of the scheme field and the encoding field.

6. The computer implemented method of claim 1, wherein the block of data comprises a first block of data and the ciphertext comprises first ciphertext, further comprising:
determining whether a compressibility of a second block of data exceeds the compression threshold; and
in response to determining that the compressibility of the second block of data does not exceed the compression threshold, performing:
encrypting the second block of data to generate second ciphertext, wherein the second ciphertext is uncompressed; and
generating in the packed stream the second ciphertext following the first ciphertext.

7. The computer implemented method of claim 1, wherein the scheme field comprises a repeated pattern repeated at least two times, wherein the storage system upon detecting the repeated pattern repeated at least two times access the ciphertext following the scheme field.

8. The computer implemented method of claim 1, wherein in response to determining that the compressibility exceeds the compression threshold, further performing:
generating a key hash from the compressed data,
wherein the generating the packed stream comprises including the key hash in the packed stream following the scheme field, wherein the storage system processes key hashes for different instances of ciphertext to perform deduplication with respect to the instances of ciphertext having a same key hash.

9. The computer implemented method of claim 8, wherein the encrypting the compressed data comprises using the key hash as a tweak to encrypt the compressed data.

10. The computer implemented method of claim 8, wherein the block of data comprises a first block of data, the ciphertext comprises first ciphertext, further comprising:
determining whether a compressibility of a second block of data exceeds the compression threshold; and
in response to determining that the compressibility of the second block of data does not exceed the compression threshold, performing:
encrypting the second block of data to generate second ciphertext, wherein the second ciphertext is uncompressed; and
generating in the packed stream the second ciphertext following the first ciphertext.

11. A computer system for packaging data to transfer to a storage system to store, comprising:
a processor set;
one or more computer-readable storage media; and
program instructions stored on the one or more computer-readable storage media to cause the processor set to perform operations comprising:
determining whether a compressibility of a block of data exceeds a compression threshold;
compressing the block of data to form compressed data;
in response to determining that the compressibility exceeds the compression threshold, performing:
encrypting the compressed data to generate ciphertext; and
generating in a packed stream a scheme field indicating the ciphertext includes compressed data, wherein the storage system processes the scheme field to access the ciphertext following the scheme field; and
transmitting the packed stream to the storage system to extract the ciphertext from the packed stream to store in the storage system.

12. The system of claim 11, wherein the generating the packed stream includes an encoding field indicating a compressed data length, wherein the storage system processes the encoding field to determine a start of a next block of data in the packed stream following the compressed data length from a start of the ciphertext, wherein ciphertext instances in the packed stream are of variable length due to compression.

13. The system of claim 12, wherein the determining whether the compressibility of the block of data exceeds the compression threshold comprises determining whether a number of bytes of the block of data less a number of bytes blocks of the compressed data is at least a number of bytes of the scheme field and the encoding field.

14. The system of claim 11, wherein the block of data comprises a first block of data and the ciphertext comprises first ciphertext, further comprising:
determining whether a compressibility of a second block of data exceeds the compression threshold; and
in response to determining that the compressibility of the second block of data does not exceed the compression threshold, performing:
encrypting the second block of data to generate second ciphertext, wherein the second ciphertext is uncompressed; and
generating in the packed stream the second ciphertext following the first ciphertext.

15. The system of claim 11, wherein in response to determining that the compressibility exceeds the compression threshold, further performing:
generating a key hash from the compressed data,
wherein the generating the packed stream comprises including the key hash in the packed stream following the scheme field, wherein the storage system processes key hashes for different instances of ciphertext to perform deduplication with respect to the instances of ciphertext having a same key hash.

16. A computer program product for packaging data to transfer to a storage system to store, comprising:
one or more computer-readable storage media; and
program instructions stored on the one or more computer-readable storage media to perform operations comprising:
determining whether a compressibility of a block of data exceeds a compression threshold;
compressing the block of data to form compressed data;
in response to determining that the compressibility exceeds the compression threshold, performing:
encrypting the compressed data to generate ciphertext; and
generating in a packed stream a scheme field indicating the ciphertext includes compressed data, wherein the storage system processes the scheme field to access the ciphertext following the scheme field; and
transmitting the packed stream to the storage system to extract the ciphertext from the packed stream to store in the storage system.

17. The computer program product of claim 16, wherein the generating the packed stream includes an encoding field indicating a compressed data length, wherein the storage system processes the encoding field to determine a start of a next block of data in the packed stream following the compressed data length from a start of the ciphertext, wherein ciphertext instances in the packed stream are of variable length due to compression.

18. The computer program product of claim 17, wherein the determining whether the compressibility of the block of data exceeds the compression threshold comprises determining whether a number of bytes of the block of data less a number of bytes blocks of the compressed data is at least a number of bytes of the scheme field and the encoding field.

19. The computer program product of claim 16, wherein the block of data comprises a first block of data and the ciphertext comprises first ciphertext, further comprising:
determining whether a compressibility of a second block of data exceeds the compression threshold; and
in response to determining that the compressibility of the second block of data does not exceed the compression threshold, performing:
encrypting the second block of data to generate second ciphertext, wherein the second ciphertext is uncompressed; and
generating in the packed stream the second ciphertext following the first ciphertext.

20. The computer program product of claim 16, wherein in response to determining that the compressibility exceeds the compression threshold, further performing:
generating a key hash from the compressed data,
wherein the generating the packed stream comprises including the key hash in the packed stream following the scheme field, wherein the storage system processes key hashes for different instances of ciphertext to perform deduplication with respect to the instances of ciphertext having a same key hash.
